(19) United States
(12) Patent Application Publication
(10) Pub. No.: US 2015/0368940 A1
(43) Pub. Date: Dec. 24, 2015

(54) DOOR-LOCK APPARATUS

(71) Applicant: SAMSUNG SDS CO., LTD., Seoul (KR)

(72) Inventors: Chul-Ho MAENG, Anyang-si (KR); Dong-Yeol KIM, Seoul (KR)

(73) Assignee: SAMSUNG SDS CO., LTD., Seoul (KR)

(21) Appl. No.: 14/630,098

(22) Filed: Feb. 24, 2015

(30) Foreign Application Priority Data
Jun. 23, 2014 (KR) 10-2014-0076737

(51) Int. Cl. E05C 1/06; G05G 11/00

(52) U.S. Cl. CPC E05C 1/06; G05G 11/00

(57) ABSTRACT

Provided is a door-lock apparatus. In the door-lock apparatus which minimizes a loss of a driving force due to a lateral pressure of a thumb-turn gear and a thumb-turn rotating body or an assembling structure of the thumb-turn rotating body and also minimizes a load of a manual operation through the thumb-turn rotating body or the assembling structure of the thumb-turn rotating body, a groove serving as an idle section of a driving force is formed at the thumb-turn rotating body or the assembling structure of the thumb-turn rotating body, and when a lever (or knob) is manually rotated to lock or unlock a lockset of the door-lock apparatus, the manual rotation of the lever (or knob) for locking or unlocking of the lockset separately from a driving motor is smoothly realized with a small force, and also a load of the driving motor is minimized.

### CROSS-REFERENCE TO RELATED APPLICATION

This application claims priority under 35 U.S.C. §119 to Korean Patent Application No. 10-2014-0076737 filed on Jun. 23, 2014, the disclosure of which is hereby incorporated by reference in its entirety.

### BACKGROUND

1. Field

Embodiments of the inventive concept relate to a door-lock apparatus, and more particularly, to a door-lock apparatus in which a groove serving as an idle section of a driving force is formed at a thumb-turn rotating body, and when a lever (or knob) is manually rotated to lock or unlock a lockset of the door-lock apparatus, the manual rotation of the lever (or knob) for locking or unlocking of the lockset separately from a driving motor is smoothly realized with a small force, and also a load of the driving motor is minimized.

2. Description of Related Art

Generally, a door-lock apparatus is installed at an inside of a door such as an entrance door and/or installed at an indoor side surface of the door so as to set or release a locking state of the door by pushing preset secret access number in turn.

As disclosed in Korean Patent No. 10-1294769 (registered on Aug. 2, 2013), the door-lock apparatus includes a lockset installed at an inside and/or an indoor side surface of a door to lock or unlock the door, an in-body installed at an inner door to be coupled with the lockset and thus to operate the lockset, and an out-body installed at an outer door to transmit a user's signal for locking or unlocking of the door.

In such a door-lock apparatus, a driving motor is installed at the in-body, and a door locking and unlocking operation of the lockset is performed by a driving force of the driving motor.

Also, the door-lock apparatus allows a manual operation through a thumb-turn knob as well as a lockset operation through the driving motor.

However, in a conventional door-lock apparatus, since a small driving motor (e.g., a geared motor) is used to install the driving motor at an inside of the in-body, it is difficult to realize a proper torque when the lockset is operated, and thus an overload is generated, and there is a problem in durability.

Also, when the lockset is manually opened and closed by the thumb-turn knob, it is very difficult for the elderly and infirm or children to rotate the thumb-turn knob gear-engaged with the driving motor due to the load of the driving motor.

### SUMMARY

Embodiments of the inventive concept provide a door-lock apparatus in which a groove serving as an idle section of a driving force is formed at a thumb-turn rotating body or an assembling structure of the thumb-turn rotating body, and when a lever (or knob) is manually rotated to lock or unlock a lockset of the door-lock apparatus, the manual rotation of the lever (or knob) for locking or unlocking of the lockset separately from a driving motor is smoothly realized with a small force.

Also, embodiments of the inventive concept provide a door-lock apparatus in which a thumb-turn rotating body or an assembling structure of the thumb-turn rotating body having a groove serving as an idle section of a driving force is applied, and a plurality of driving motors are applied so as to rotate a gear part, and thus it is possible to minimize a loss of a driving force of the driving motor due to a lateral pressure of the gear part and the thumb-turn rotating body or the assembling structure of the thumb-turn rotating body.

The technical objectives of the inventive concept are not limited to the above disclosure; other objectives may become apparent to those of ordinary skill in the art based on the following descriptions.

In accordance with an aspect of the inventive concept, a door-lock apparatus includes a thumb-turn gear rotated by driving operations of driving motors; and a thumb-turn rotating body rotated by the thumb-turn gear or a manual operation of a user to lock and unlock a lockset, wherein a protrusion is formed at the thumb-turn gear, and a groove serving as an idle section of a driving force is formed at the thumb-turn rotating body so that the thumb-turn rotating body is interlocked with a gear part when the protrusion is caught therein, and rotation of the thumb-turn rotating body is separated from a driving force of the driving motors when the protrusion is released therefrom.

In accordance with another aspect of the inventive concept, a door-lock apparatus includes a thumb-turn gear rotated by driving operations of driving motors; a shaft holder rotated by the thumb-turn gear or a manual operation of a user; and a shaft connected with the shaft holder so as to be interlocked with the shaft holder when the shaft holder is rotated and thus to lock or unlock a lockset, wherein a protrusion is formed at the thumb-turn gear, and a groove serving as an idle section of a driving force is formed at the shaft holder so that the shaft holder is interlocked with a gear part when the protrusion is caught therein, and rotation of the shaft holder is separated from a driving force of the driving motors when the protrusion is released therefrom.

In accordance with still another aspect of the inventive concept, a door-lock apparatus includes a thumb-turn gear rotated by driving operations of driving motors; a thumb-turn knob rotated by the thumb-turn gear or a manual operation of a user; a shaft holder connected to the thumb-turn knob; and a shaft connected with the shaft holder so as to be interlocked with the shaft holder, when the shaft holder is rotated, and thus to lock or unlock a lockset, wherein a protrusion is formed at the thumb-turn gear, and a groove serving as an idle section of a driving force is formed at the shaft holder so that the shaft holder is interlocked with the gear part when the protrusion is caught therein, and rotation of the shaft holder is separated from a driving force of the driving motors when the protrusion is released therefrom.

In accordance with yet another aspect of the inventive concept, a door-lock apparatus includes a thumb-turn gear rotated by driving operations of driving motors; a thumb-turn knob rotated by the thumb-turn gear or a manual operation of a user; and a shaft connected with the thumb-turn knob so as to be interlocked with the thumb-turn knob, when the thumb-turn knob is rotated, and thus to lock or unlock a lockset, wherein a protrusion is formed at the thumb-turn gear, and a groove serving as an idle section of a driving force is formed at the shaft so that the shaft is interlocked with a gear part when the protrusion is caught therein, and rotation of the shaft is separated from a driving force of the driving motors when the protrusion is released therefrom.

In accordance with yet another aspect of the inventive concept, a door-lock apparatus includes a thumb-turn gear rotated by driving operations of driving motors; and a thumb-turn rotating body rotated by the thumb-turn gear or a manual operation of a user to lock and unlock a lockset, wherein a gear part is formed on a on a circumference of the thumb-turn gear, and the driving motors are arranged in each of first and second directions of the thumb-turn gear to increase a rotating force of the thumb-turn gear and gear-engaged with the gear part of the thumb-turn gear.

In accordance with yet another aspect of the inventive concept, a door-lock apparatus includes a thumb-turn gear rotated by driving operations of driving motors; a shaft holder rotated by the thumb-turn gear or a manual operation of a user; and a shaft connected with the shaft holder so as to be interlocked with the shaft holder when the shaft holder is rotated and thus to lock or unlock a lockset, wherein a gear part is formed on a on a circumference of the thumb-turn gear, and the driving motors are arranged in each of first and second directions of the thumb-turn gear to increase a rotating force of the thumb-turn gear and gear-engaged with the gear part of the thumb-turn gear.

In accordance with yet another aspect of the inventive concept, a door-lock apparatus includes a thumb-turn gear rotated by driving operations of driving motors; a thumb-turn knob rotated by the thumb-turn gear or a manual operation of a user; a shaft holder connected to the thumb-turn knob; and a shaft connected with the shaft holder so as to be interlocked with the shaft holder, when the shaft holder is rotated, and thus to lock or unlock a lockset, wherein a gear part is formed on a on a circumference of the thumb-turn gear, and the driving motors are arranged in each of first and second directions of the thumb-turn gear to increase a rotating force of the thumb-turn gear and gear-engaged with the gear part of the thumb-turn gear.

In accordance with yet another aspect of the inventive concept, a door-lock apparatus includes a thumb-turn gear rotated by driving operations of driving motors; a thumb-turn knob rotated by the thumb-turn gear or a manual operation of a user; and a shaft connected with the thumb-turn knob so as to be interlocked with the thumb-turn knob, when the thumb-turn knob is rotated, and thus to lock or unlock a lockset, wherein a gear part is formed on a on a circumference of the thumb-turn gear, and the driving motors are arranged in each of first and second directions of the thumb-turn gear to increase a rotating force of the thumb-turn gear, and gear-engaged with the gear part of the thumb-turn gear.

In some embodiments, a gear part may be formed on a circumference of the thumb-turn gear, and the driving motors may be arranged in each of first and second directions of the thumb-turn gear to increase a rotating force of the thumb-turn gear, and gear-engaged with the gear part of the thumb-turn gear.

In another embodiment, the driving motors arranged in each of the first and second directions of the thumb-turn gear may be rotated in the same direction by an electric signal.

In yet another embodiment, the shaft holder and the thumb-turn knob may be coupled with each other by a screw.

In yet another embodiment, the shaft and the thumb-turn knob may be coupled with each other by a screw.

In yet another embodiment, the thumb-turn rotating body may include a circular plate in which a groove serving as an idle section of a driving force is formed at a circumference thereof.

In yet another embodiment, the groove may be formed at a predetermined area on the circumference of the circular plate so that the thumb-turn rotating body is rotated by the thumb-turn gear when the protrusion is in contact with a stepped surface of the groove.

In yet another embodiment, the shaft holder may have a holder formed at a center area thereof, and may include a circular plate in which a groove serving as an idle section of a driving force is formed at a circumference thereof.

In yet another embodiment, the groove may be formed at a predetermined area on the circumference of the circular plate so that the shaft holder is rotated by the thumb-turn gear when the protrusion is in contact with a stepped surface of the groove.

### BRIEF DESCRIPTION OF THE DRAWINGS

The foregoing and other features and advantages of the inventive concepts will be apparent from the more particular description of preferred embodiments of the inventive concepts, as illustrated in the accompanying drawings in which like reference characters refer to the same parts throughout the different views. The drawings are not necessarily to scale, emphasis instead being placed upon illustrating the principles of the inventive concepts. In the drawings:

FIG. 1 is a schematic perspective view of a door-lock apparatus in accordance with an embodiment of the inventive concept;

FIG. 2 is a partially cross-sectional perspective view of the door-lock apparatus in accordance with an embodiment of the inventive concept;

FIG. 3 is a schematic plan view of a part of the door-lock apparatus in accordance with another embodiment of the inventive concept; and

FIGS. 4A to 5B are schematic perspective views of operation states of the door-lock apparatus in thumb-turn operators in accordance with another embodiment of the inventive concept.

### DETAILED DESCRIPTION OF MAIN ELEMENT

| | |
|---|---|
| 10: door | 100: door-lock body |
| 110: thumb-turn gear | 111: protrusion |
| 120: driving motor | 130: shaft holder |
| 131: groove | 140: shaft |
| 150: idle section | 200: thumb-turn knob |
| 210: screw | 300: lockset |

### Detailed Description of the Embodiments

Various embodiments will now be described more fully with reference to the accompanying drawings in which some embodiments are shown. These inventive concepts may, however, be embodied in different forms and should not be construed as limited to the embodiments set forth herein. Rather, these embodiments are provided so that this disclosure is thorough and complete and fully conveys the inventive concept to those skilled in the art. The present invention is defined only by the scope of the claims.

The terminology used herein is for the purpose of describing particular embodiments only and is not intended to be limiting of the present inventive concept. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Also, embodiments are described herein with reference to cross-sectional and/or plane illustrations that are schematic illustrations of idealized embodiments. The same components are designated by the same reference numerals throughout the specification, even though they are depicted in different drawings. Therefore, even if the same or like reference numerals are not referred or described in a related drawing, they may be described with reference to another drawing. Further, even if an element is not assigned a reference numeral in a drawing, this element may be described with reference to other drawings.

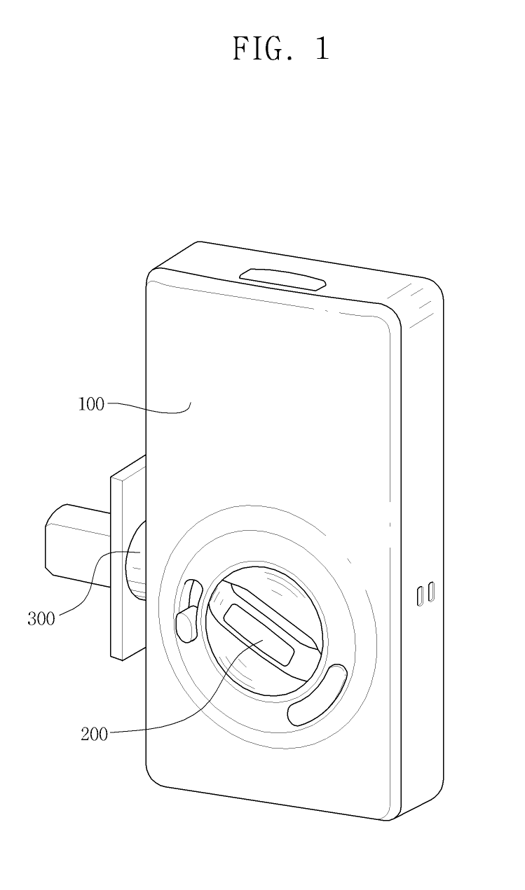

FIG. 1 is a schematic perspective view of a door-lock apparatus in accordance with an embodiment of the inventive concept.

Referring to FIG. 1, the door-lock apparatus in accordance with an embodiment of the inventive concept may include a door-lock body 100, a thumb-turn knob 200, and a lockset 300.

The door-lock body 100 is fixed to a door and has a driving motor or the like installed therein.

The thumb-turn knob 200 may be manually operated by a user and may generate a rotating force which locks or unlocks the lockset 300.

The lockset 300 is installed at an inside of the door, and operated by a driving force of the driving motor in the door-lock body 100 or a driving force of the thumb-turn knob 200 so as to perform locking and unlocking operations of the door.

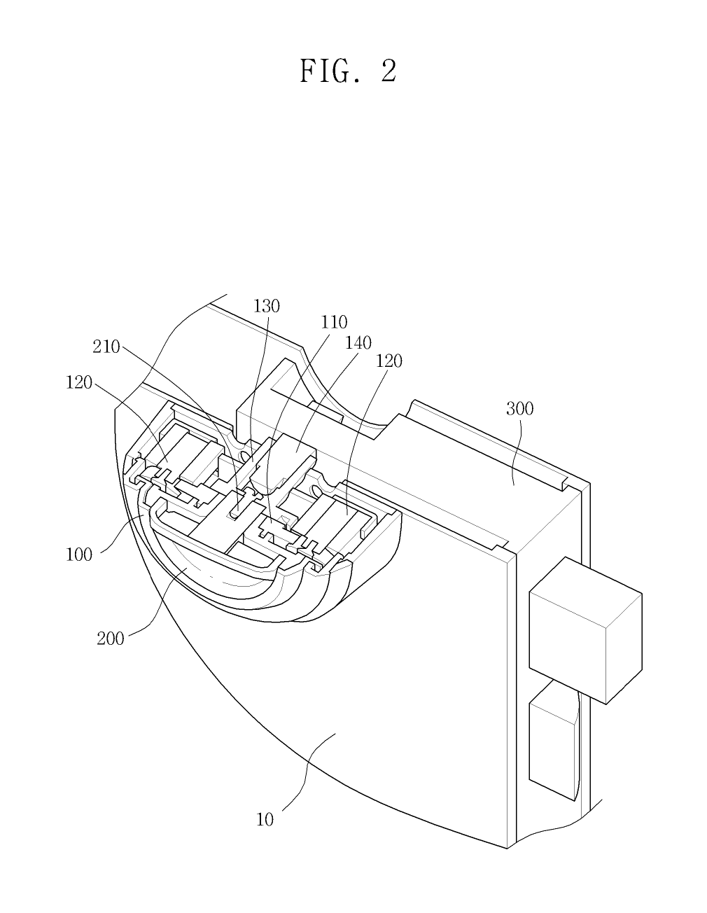

FIG. 2 is a partially cross-sectional perspective view of the door-lock apparatus in accordance with an embodiment of the inventive concept.

Referring to FIG. 2, the door-lock apparatus in accordance with an embodiment of the inventive concept may include the door-lock body 100, a thumb-turn gear 110, a driving motor 120, the thumb-turn knob 200, the lockset 300, a shaft holder 130, and a shaft 140.

Here, the thumb-turn knob 200, the shaft holder 130, and the shaft 140 may be respectively separated, coupled again, and then applied to the door-lock apparatus, or a thumb-turn rotating body in which the thumb-turn knob 200, the shaft holder 130, and the shaft 140 are integrated into one structure may be formed and then may be applied to the door-lock apparatus, or only the shaft holder 130 and the shaft 140 may be applied to the door-lock apparatus, or only the thumb-turn knob 200 and the shaft 140 may be applied to the door-lock apparatus. Therefore, the door-lock apparatus may be selectively provided in the door, or at an inside or an indoor side surface of the door, or at the inside and the indoor side surface of the door. However, a separated structure will be described below.

The door-lock body 100 is installed at an outside of the door 10.

The thumb-turn knob 200 is installed at an outside of the door-lock body 100 to allow a user's manual operation and to generate the rotating force which locks or unlocks the lockset 300.

The thumb-turn gear 110 may be installed at an inside of the door-lock body 100 and may have a gear part formed on a circumference thereof to be gear-engaged with the driving motor 120, and thus may rotate the shaft holder 130 according to the driving force of the driving motor 120.

The driving motor 120 may be operated by an electric signal for locking and unlocking of the door 10 so as to rotate the thumb-turn gear 110. The driving motor 120 is gear-engaged with the gear part formed on the circumference of the thumb-turn gear 110, and a plurality of driving motors 120 may be arranged in a first direction (a left side or an upper portion) of the thumb-turn gear 110 and a second direction (a right side or a lower portion) thereof to be gear-engaged therewith, respectively. The plurality of the driving motors 120 serve to generate a rotational driving force in the same direction by the electric signal and to increase the rotating force of the thumb-turn gear 110.

The shaft holder 130 may have a holder formed at a center area thereof, and a lower surface of the shaft holder 130 may be formed in a circular plate shape. The circular plate of the shaft holder 130 may be formed at an upper portion of the thumb-turn gear 110. The circular plate of the shaft holder 130 may be coupled and fixed to the thumb-turn knob 200. The coupling between the shaft holder 130 and the thumb-turn knob 200 may be coupled and fixed to each other by a screw 210. The shaft holder 130 may be rotated by rotation of the thumb-turn gear 110 due to an operation of the driving motor 120 or may be rotated by an operation of the thumb-turn knob 200.

The shaft 140 is fixed to the holder of the shaft holder 130 so as to be rotated by the rotating force of the shaft holder 130 and to directly perform the locking or unlocking of the lockset 300.

The lockset 300 is coupled with the shaft 140 to perform the locking and unlocking operation of the door 10.

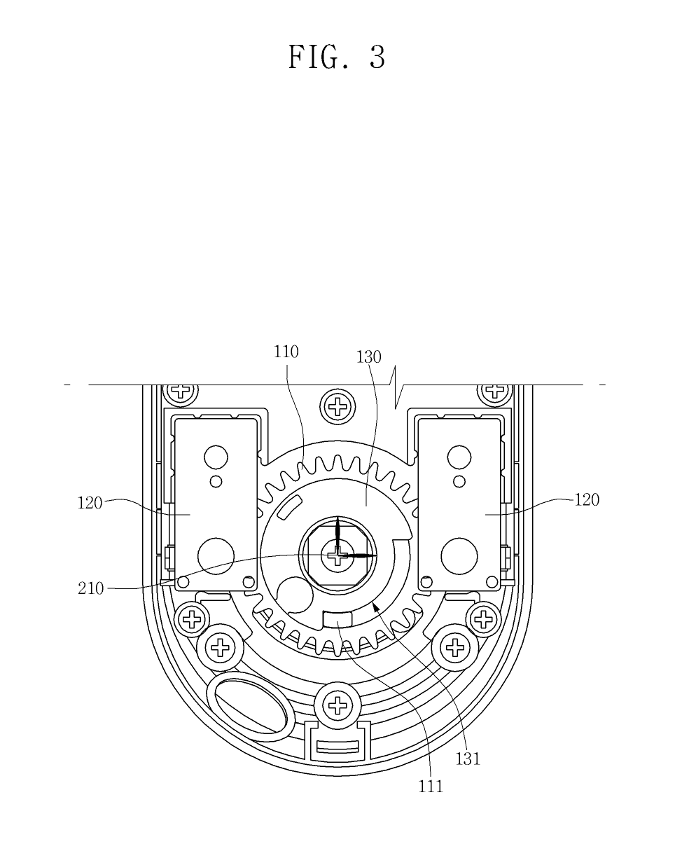

FIG. 3 is a schematic plan view of a part of the door-lock apparatus in accordance with another embodiment of the inventive concept.

Referring to FIG. 3, a groove 131 serving as an idle section of the driving force may be formed at a predetermined area on the circumference of the circular plate of the shaft holder 130. The predetermined area on the circumference of the circular plate having the groove 131 may have a circumference having a relatively small diameter, compared with that of other area thereof. A stepped surface due to a difference in the diameter may be formed on the circumference of the circular plate by the groove 131. The groove 131 may be formed at ¼ of a diameter area on the circumference of the circular plate, but is not limited to such a numeral limitation.

A protrusion 111 may be formed at a predetermined area of the thumb-turn gear 110. The protrusion 111 may be formed to correspond to the groove 131 formed at the circular plate of the shaft holder 130.

Due to such a structure, in the door-lock apparatus in accordance with another embodiment of the inventive concept, the thumb-turn gear 110 is rotated by operations of the plurality of driving motors 120, and the protrusion 111 of the thumb-turn gear 110 is caught on the stepped surface formed at the groove 131 of the shaft holder 130, and thus the rotating force of the thumb-turn gear 110 may be transmitted to the shaft holder 130.

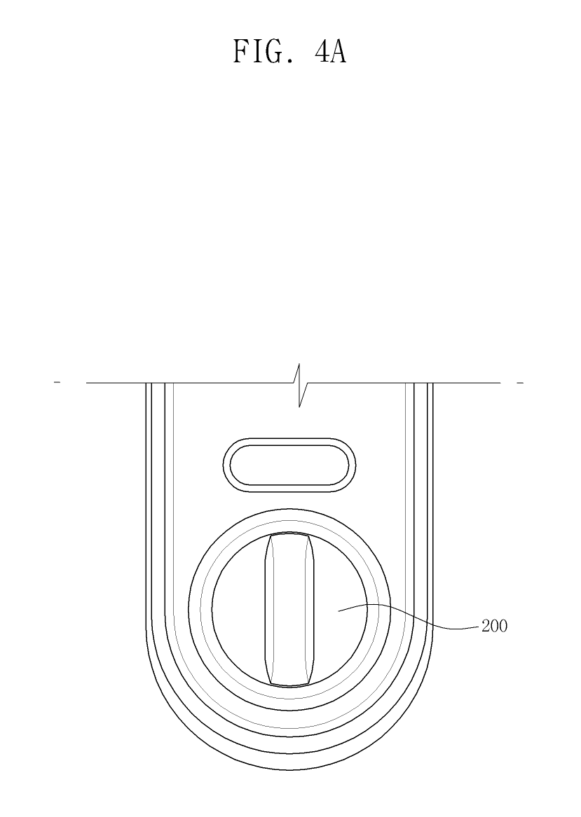

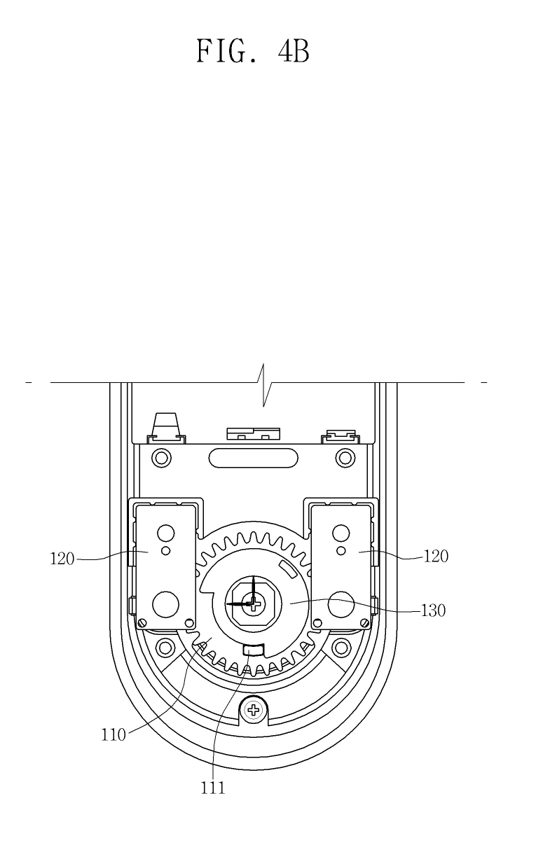

FIGS. 4 to 7 are schematic perspective views of operation states of the door-lock apparatus in thumb-turn operators in accordance with another embodiment of the inventive concept.

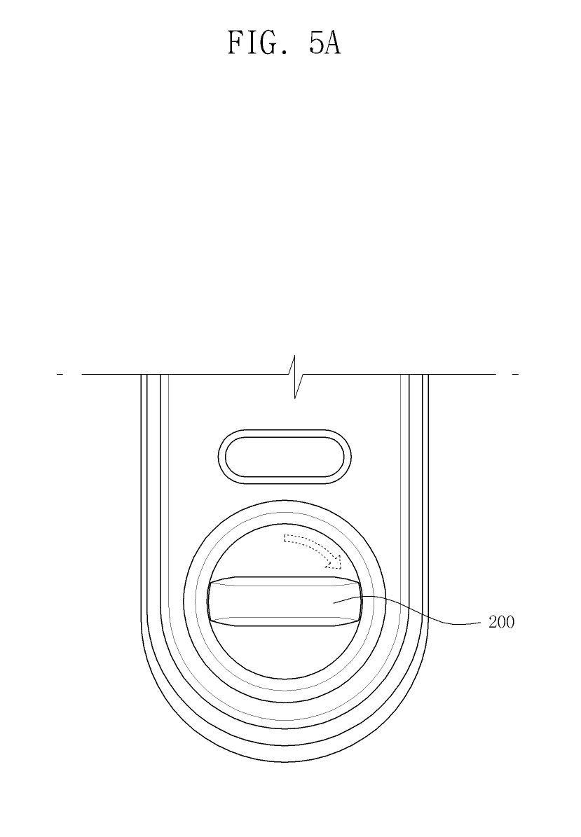

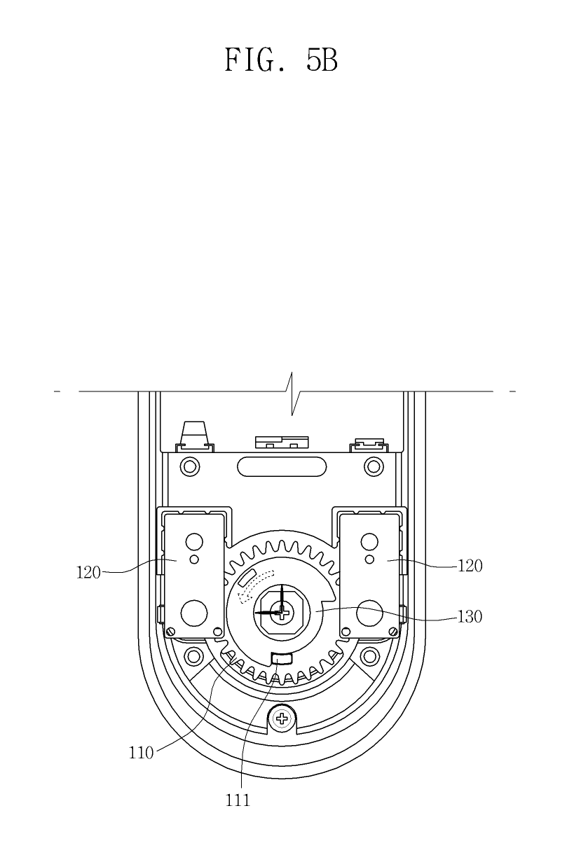

Referring to FIGS. 4 and 5, when the driving motors 120 are operated to lock and unlock the door, the rotating force of the thumb-turn gear 110 is transmitted to the shaft holder 130 through the protrusion 111, and the shaft holder 130 is rotated by the transmitted rotating force, and thus the thumb-turn knob 200 fixed to the shaft holder 130 is also rotated.

In the operation of the door-lock apparatus by the driving motors 120, when the user rotates manually the thumb-turn knob 200 to lock and unlock the door, as illustrated in FIG. 6, the shaft holder 130 fixed to the thumb-turn knob 200 is rotated to generate a driving force for operating the lockset 300.

However, since the protrusion 111 formed at the thumb-turn gear 110 is released from the stepped surface of the groove 131 by the groove 131 serving as the idle section of the driving force formed at the circular plate of the shaft holder 130, when the user rotates manually the thumb-turn knob 200 or a lever of the door-lock apparatus, the rotating force of the thumb-turn gear 110 gear-engaged with the plurality of the driving motors 120, i.e., the driving force of the driving motors 120 rotating the thumb-turn gear 110 is separated in the manual rotation, and thus not transmitted to the rotating force of the thumb-turn knob 200.

That is, the groove 131 serves as an idle section 150 of the driving force, and is separated from the thumb-turn gear 110, and thus when the thumb-turn knob 200 is manually rotated, the shaft holder 130 is rotated, but the rotating force of the thumb-turn gear 110 gear-engaged with the plurality of driving motors 120 is separated and thus does not affect the rotation of the thumb-turn knob 200.

Therefore, when the user rotates manually the thumb-turn knob 200, a load due to the gear engagement between the driving motors 120 and the thumb-turn gear 110 is not applied to the rotating force to the thumb-turn knob 200, and thus since the manual rotating force of the thumb-turn knob 200 is not transmitted to the driving motors 120, a weak user, a child, or the elderly and infirm may easily rotate manually the thumb-turn knob 200 with a small force at an indoor side.

According to the door-lock apparatus in accordance with embodiments of the inventive concept, when the manual operation is performed by the thumb-turn rotating body or the assembling structure of the thumb-turn rotating body, the idle section is formed to minimize the load and also to prevent the lateral pressure of the thumb-turn rotating body or the assembling structure of the thumb-turn rotating body from being generated, thereby minimizing the loss of the driving force of the driving motor.

The foregoing is illustrative of embodiments and is not to be construed as limiting thereof. Although a few embodiments have been described, those skilled in the art will readily appreciate that many modifications are possible in embodiments without materially departing from the novel teachings and advantages. Accordingly, all such modifications are intended to be included within the scope of this inventive concept as defined in the claims. In the claims, means-plus-function clauses are intended to cover the structures described herein as performing the recited function, and not only structural equivalents but also equivalent structures. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A door-lock apparatus comprising:
a thumb-turn gear comprising a gear part formed on a circumference thereof and configured to be rotated by a driving motor; and
a thumb-turn rotating body configured to be rotated by the thumb-turn gear to lock and unlock a lockset,
wherein the driving motor comprises a first driving motor and a second driving motor, and,
wherein the first driving motor is provided on a first position and the second driving motor is provided on a second position opposite to the first position with respect to a center of the thumb-turn gear to increase a rotating force of the thumb-turn gear, and the first and second driving motors are gear-engaged with the gear part of the thumb-turn gear.

2. The door-lock apparatus according to claim 1, wherein the thumb-turn gear further comprises a protrusion,
wherein the thumb-turn rotating body comprises a groove serving as an idle section of a driving force of the driving motor, and
wherein the thumb-turn rotating body is configured to interlock with the gear part when the protrusion is caught in the groove, and rotation of the thumb-turn rotating body is configured to be separated from the driving force of the first and second driving motors when the protrusion is released from the groove.

3. The door-lock apparatus according to claim 1, wherein the first and second driving motors are configured to exert the rotating force in the same direction relative to the thumb-turn gear, by an electric signal.

4. The door-lock apparatus according to claim 2, wherein the thumb-turn rotating body comprises a circular plate in which the groove is formed at a circumference thereof, and
the groove is formed in a predetermined area on the circumference of the circular plate and the thumb-turn rotating body is rotated by the thumb-turn gear when the protrusion is in contact with a stepped surface of the groove.

5. A door-lock apparatus comprising:
a thumb-turn gear comprising a gear part formed on a circumference thereof and configured to be rotated by driving motors;
a shaft holder configured to be rotated by the thumb-turn gear to lock or unlock a lockset; and
a shaft connected with the shaft holder to be interlocked with the shaft holder,
wherein the driving motors are respectively arranged at opposite sides with respect to a center of the thumb-turn gear to increase a rotating force of the thumb-turn gear, and are gear-engaged with the gear part of the thumb-turn gear.

6. The door-lock apparatus according to claim 5, wherein the thumb-turn gear further comprises a protruding body,
wherein the thumb-turn rotating body comprises a groove serving as an idle section of a driving force of the driving motors, and
wherein the shaft holder is configured to interlock with the gear part when the protruding body is caught in the groove, and rotation of the shaft holder is configured to be separated from the driving force of the driving motors when the protruding body is released from the groove.

7. The door-lock apparatus according to claim 5, wherein the driving motors are configured to exert the rotating force in the same direction relative to the thumb-turn gear, by an electric signal.

8. The door-lock apparatus according to claim 6, wherein the shaft holder comprises:
a holder formed in a center area of the shaft holder; and
a circular plate in which the groove is formed at a circumference thereof, and
the groove is formed in a predetermined area on the circumference of the circular plate and the shaft holder is rotated by the thumb-turn gear when the protruding body is in contact with a stepped surface of the groove.

9. A door-lock apparatus comprising:
a thumb-turn gear comprising a gear part formed on a circumference thereof and configured to be rotated by driving motors;
a thumb-turn knob configured to be rotated by the thumb-turn gear to lock or unlock a lockset;
a shaft holder connected to the thumb-turn knob; and
a shaft connected with the shaft holder so as to be interlocked with the shaft holder t,
wherein the driving motors are respectively arranged at opposite positions with respect to a center of the thumb-turn gear to increase a rotating force of the thumb-turn gear, and are gear-engaged with the gear part of the thumb-turn gear.

10. The door-lock apparatus according to claim 9, wherein the thumb-turn gear further comprises a protrusion, and
wherein the thumb-turn rotating body comprises a groove serving as an idle section of a driving force of the driving motors, and
wherein the shaft holder is configured to interlock with the gear part when the protrusion is caught in the groove, and rotation of the shaft holder is configured to be separated from a driving force of the driving motors when the protrusion is released from the groove.

11. The door-lock apparatus according to claim 9, wherein the driving motors are configured to exert the rotating force in the same direction relative to the thumb-turn gear, by an electric signal.

12. The door-lock apparatus according to claim 10, wherein the shaft holder comprises:
a holder formed in a center area of the shaft holder; and
a circular plate in which the groove is formed at a circumference thereof, and
the groove is formed in a predetermined area on the circumference of the circular plate and the shaft holder is rotated by the thumb-turn gear when the protrusion is in contact with a stepped surface of the groove.

13. The door-lock apparatus according to claim 9, wherein the shaft holder and the thumb-turn knob are coupled with each other by a screw.

14. A door-lock apparatus comprising:
a thumb-turn gear comprising a gear part formed on a circumference thereof, and configured to be rotated by driving motors;
a thumb-turn knob configured to be rotated by the thumb-turn gear or a manual operation to lock or unlock a lockset; and
a shaft connected with the thumb-turn knob to be interlocked with the thumb-turn knob,
wherein the driving motors are respectively arranged at opposite ends with respect to a center of the thumb-turn gear to increase a rotating force of the thumb-turn gear, and are gear-engaged with the gear part of the thumb-turn gear.

15. The door-lock apparatus according to claim 14, wherein the thumb-turn gear comprises a protrusion, and
the shaft comprises a groove serving as an idle section of a driving force so that the shaft is configured to interlock with the gear part when the protrusion is caught in the groove, and rotation of the shaft is configured to be separated from a driving force of the driving motors when the protrusion is released from the groove.

16. The door-lock apparatus according to claim 14, wherein the driving motors are configured to exert the rotating force in the same direction relative to the thumb-turn gear, by an electric signal.

17. The door-lock apparatus according to claim 15, wherein the groove is formed in a predetermined area on a circumference of a circular plate of the shaft.

18. The door-lock apparatus according to claim 14, wherein the shaft and the thumb-turn knob are coupled with each other by a screw.
